(19) United States
(12) Patent Application Publication
(10) Pub. No.: US 2009/0309877 A1
(43) Pub. Date: Dec. 17, 2009

(54) SOFT SHADOW RENDERING

(75) Inventors: John Snyder, Redmond, WA (US); Derek Nowrouzezahrai, Toronto (CA)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/139,512

(22) Filed: Jun. 16, 2008

(51) Int. Cl. G06T 15/60

(52) U.S. Cl. 345/426

(57) ABSTRACT

A real-time method for rendering soft shadows from lighting environments on dynamic height fields provides for self-shadowing by computing a horizon map for set azimuthal directions with a multiple resolution pyramid on the height field. The multiple resolution pyramid comprises more levels than power of two levels. Visibility is represented by an order-4 spherical harmonic (SH) basis. The method is local, parallel and substantially performance independent of geometric content, and may allow for soft shadows to be rendered in a computer game, for example.

### BACKGROUND

In some computer applications, such as gaming and/or flight simulations, for example, 3D animation may be used to display a sequence of images interactively to the user, which gives the illusion of motion in three-dimensional space. This interactivity allows a user to change a scene or the point of view in the scene, among other things. These on-demand changes initiated by the user require a rendering system that can create new images in real-time, which can be a computationally intensive process. Accordingly, a 3D graphics accelerator is typically used to meet these demands by receiving off-loaded processing functions from a host processor to speed up system performance.

It can be appreciated that shadows play a role in providing cues for perceiving sizes, shapes, textures, etc. in 3D images, and thus for providing a user with a more realistic (virtual) experience. However, rendering shadows in a 3D context can comprise a substantial part of the large amount of computations needed for 3D image generation and/or manipulation, particularly where soft shadows are (attempted to be) generated and represented. Soft shadows generally comprise shadows that are cast from an object that blocks some, but not all, of the ambient light from multiple light sources, and thus allow underlying features or objects to still be seen through the shadow (although in a darkened or shadowed state). Soft shadows are thus, in a sense, translucent in that underlying objects or features are still visible through them. It can be thus be appreciated that a significant number of calculations may need to be performed to generate a soft shadow in a virtual environment (that mimics a real world soft shadow) since, among other things, the relationships between many different lighting sources and shadow casting and shadow receiving objects have to be considered. Moreover, these demands are exacerbated in some 3D contexts, such as gaming and/or flight simulations, for example, where there is significant movement among and between different objects and/or light sources relative to one another.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, soft shadows are developed or rendered in an efficient manner that produces soft shadows at a relatively high granularity, thus providing a user with a more realistic virtual experience while placing fewer demands on computational resources. In particular, soft shadows are developed using a multiple resolution pyramid, and are represented through a spherical harmonic basis in one embodiment.

A multiple resolution pyramid is a term of art. It can be a data structure designed to support scaled image representation (e.g., to present smaller or larger instances of an image that still have an acceptable appearance or level of resolution or granularity). It is to be noted that a multiple resolution pyramid relates to an image processing or rendering technique, and not to a physical or tangible (pyramid like) structure.

Spherical harmonics are techniques that allow an image to be represented in a spherical coordinate system. Spherical harmonics are used in theoretical and practical applications. In 3D computer graphics, spherical harmonics play a role in a wide variety of topics including indirect lighting (e.g., ambient occlusion, global illumination, precomputed radiance transfer etc) and in recognition of 3D shapes.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is an illustration of an exemplary blocking angle of a height field as may be consulted in soft shadow rendering as provided herein.

FIG. 1B is an illustration of an exemplary azimuthal swath on a height field as may be consulted in soft shadow rendering as provided herein.

FIG. 2 is a flow chart illustrating an exemplary method of extracting a horizon map for rendering soft shadows from a light environment.

FIG. 3 is a flow chart illustrating an exemplary method of rendering soft shadows on height fields.

FIGS. 4A, 4B, and 4C are illustrations of exemplary visibility wedges as may be used in rendering soft shadows as provided herein.

FIG. 5 is an illustration of an exemplary computer-readable medium comprising processor-executable instructions configured to embody one or more of the provisions set forth herein.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, soft shadows are generated by using certain techniques, such as multiple resolution pyramids and spherical harmonics. Examples of applications for soft shadows include 3D video games, flight simulators, terrains and/or topographical maps, etc. It will be appreciated that soft-shadows represented using spherical harmonics (SH) provide soft shadow renderings different from other techniques. For example, spherical harmonics provide improved results in the area of self-shadowing, where multiple elements of an item may cast shadows upon one another. For example, without self-shadowing, if a character in a video game puts his or her right arm over the left, the right arm will not cast a shadow over the left arm.

Spherical harmonics are an example of an area-supported basis for a visibility hemisphere and are merely one means for representing visibility in a hemisphere (e.g., background). Other examples that could also be employed are known by one of ordinary skill in the art and can be other low-frequency basis and/or any basis for representing visibility functions over a hemisphere based on more sampled values in a particular direction (e.g., azimuthal direction).

The methods herein can be implemented on a CPU to achieve interactive performance and/or mapped to fast graphics GPUs to further improve performance.

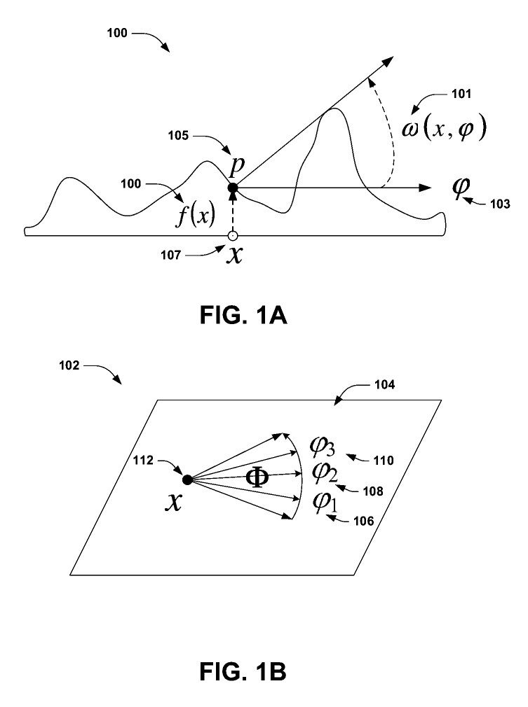

FIGS. 1A and 1B illustrate some basic principles related to generating soft-shadows with multiple resolution pyramids. A multiple resolution pyramid is used to filter images or height fields at various resolutions to create smaller and smaller versions of the same image. For example, an object may become blurrier the farther away one is from it, but objects become finer/clearer the closer one is to it. This effect is a resolution pyramid with a sequence of copies of an original image (with closer images having a finer resolution than images that are farther away). This technique is used for generating a surface/horizon map, and thereafter the samples can be used to render soft shadows thereon, as discussed infra.

Generally speaking, a multiple resolution pyramid represents a series of images of a particular object, landscape, etc. at various resolutions (e.g., from fine to coarse). The various resolutions allow sampling to be performed in order to obtain a map of the surface or a horizon map to provide a representation of a soft shadow. The samples are taken of different distances between a point that a shadow is being cast on (e.g., a receiver point) and a point on the object that is casting the shadow (e.g., a castor point). Once enough samples are obtained an approximation of the actual shadow can be represented graphically, for example, in a virtual environment. In one example, many different directions are sampled in order to obtain an accurate representation of how much of a field of view, such as the sky, for example, is blocked at different horizon angles.

Principles of height fields are referenced herein for generating soft shadows, where a height field is a visual representation of a function which takes as input a two-dimensional point and returns a scalar value (“height”) as output. In other words, a function f takes x and y coordinates and returns a z coordinate to generate a height field. A height field can also be thought of as a height for points on a given plane relative to a base or reference plane. In a further example, a height field can be illustrated by pixels of a processed image where respective pixels of the image may be constrained to a single color (e.g., gray) and the respective intensities of the different pixels on different height fields would vary depending on the height above a reference plane.

FIG. 1A is an illustration of an exemplary blocking angle 101 for a point as a function of an azimuthal direction 103 as may be used to determine a horizon map or map of a horizon surface which can be used in rendering soft shadows, where the azimuthal direction 103 is one of various angles upon which one may view a horizon. A multiple resolution pyramid can be used to filter these samples that will afterwards be represented graphically. More particularly, a blocking angle ω 101 for point p 105 is illustrated as a function of the azimuthal direction φ 103. If shadows are to be computed for a particular point on a horizon, such as p 105, for example, a sample is taken in one azimuthal direction 103 relative to that point, and a scan of a height field 109 can be made to determine a horizon angle or blocking angle 101. The horizon angle 101 is generally the largest angle where the height field 109 blocks light between the receiver point p 105 (which is a sample source) and a chosen direction. For example, the amount of shadow created by a mountain, as viewed in a certain azimuthal direction by an observer, relates to the amount of a certain field of view (e.g., sky) that is blocked by (the height of) the mountain. The height of the mountain, for example, correlates to the height field 109 which is blocking light between the observer or receiver point 105 given the direction that the observer has chosen to view, namely the azimuthal direction 103. The horizon angle 101 and the height field 109, as represented by a function, therefore, determine how shadowed point 105 is on the horizon, and consequently both are used herein for determining soft shadows.

It will be appreciated that two dimensional (2D) points in FIG. 1A are denoted as 107 at point x, for example a mathematical representations is x=(x,y) where x is a coordinate and y is another coordinate in a rectangular Cartesian coordinate system. A height field 109 (scalar function of two variables) is denoted as ƒ(x)=ƒ(x,y). The height field is tabulated with sampling various resolutions of nₓ×n_{y}=n×(α,n), for example a 512×512 resolution screen/image, and where α is an aspect ratio.

The height field 109 may also determine a three dimensional (3D) surface z=f(x) with 3D points 105, p=(x,y,f(x,y)), which for example are to be shaded with soft shadows. To do this, at respective points at x 107 visibility is computed in azimuthal directions 103, for example, parameterized by (cos φ, sin φ), φ ∈ [0,2π] (azimuthal directions are directions across the 2D plane of the height field 109). An image or a height field at a particular resolution level may be filtered to create smaller and smaller versions of the same image thereby giving the effect of a resolution pyramid. For example, an object may become blurrier the farther away one is from it, but objects become finer/clearer the closer on is to it. This effect is a resolution pyramid with a sequence of copies of an original image. This technique is used to filter samples of the height differences between a given receiver point (where shadowing is being cast) and a shadow castor point (point casting the shadow) for generating a surface/horizon map, and thereafter the samples can be used to render soft shadows thereon, as discussed infra.

Visibility (e.g., shadows) can be represented in terms of a desired elevation angle 101 that the height field's horizon reaches in the φ azimuthal direction 103, as seen from p 105, for example. This is called the horizon elevation angle or blocking angle 101 at p in the azimuthal direction φ, and is denoted ω(x,φ) for purposes of equation representation. At elevations below this blocking angle 101, the direction is blocked by the height field 109 and cannot see the sky.

To compute shadows on the height field in a given azimuthal direction according to one aspect of the present disclosure, an approximately maximum blocking angle in that direction is computed. This can be done by sampling the height difference between a given receiver point on the height field (e.g., point to be shaded, requiring a calculation of how much it is shadowed) and many shadow caster points on the height field at different distances away from the receiver point in a given azimuthal direction. The resultant calculation is a sampling for many different horizon angles for various azimuthal directions at points on the height field.

Without any prefiltering or a priori knowledge of the height field geometry, the height field variation is sampled in one example using a fixed number of samples per unit distance. As the (exponential) distance scale to the receiver point increases, exponentially more caster points can be sampled. The problem is exacerbated if samples are taken over an azimuthal swath rather than in a single direction, because the sampling pattern becomes 2D instead of 1D. The advantage of a multiple resolution pyramid then becomes apparent by providing a filter for the samples obtained of the different horizon angles for various azimuthal directions points on the height field.

FIG. 1B illustrates an azimuthal swath set Φ, 102, on a height field 104, at a receiver point x 112, containing n_{φ}=3 azimuthal direction samples, φ, 1 φ2, φ3, respectively 106, 108, 110. Light is presumed to come from directions within the swath 102, therefore one aspect of the present disclosure computes visibility over these particular directions, 106, 108, 110, which are not confined to any particular angle as illustrated in FIG. 1B for purposes of explanation.

FIG. 1B illustrates shadowing considerations relative to different azimuthal directions, 106, 108, 110, for example. An area light, for example, will subtend a continuous swath set 102 of azimuthal directions 106, 108, 110. To account for the light's full extent, several different directions are sampled in one present disclosure method within an azimuthal swath: φ∈Φ=[Φ₀, Φ₁], for example, with the extent of the azimuthal swath denoted by Δ_{Φ}=Φ₀−Φ₁.

In another example, an azimuthal swath 102 can be compartmentalized into a set of azimuthal direction samples. If the light is strongly directional (i.e., comes from one side of the height field only), shadow sampling may be done within a small azimuthal swath 102, while broader area lights would use a larger swath, for example. Lights positioned directly above the height field 104 or surrounding all sides of the height field 104 may be sampled using a complete swath 102 of a 360° or Φ=[0,2π].

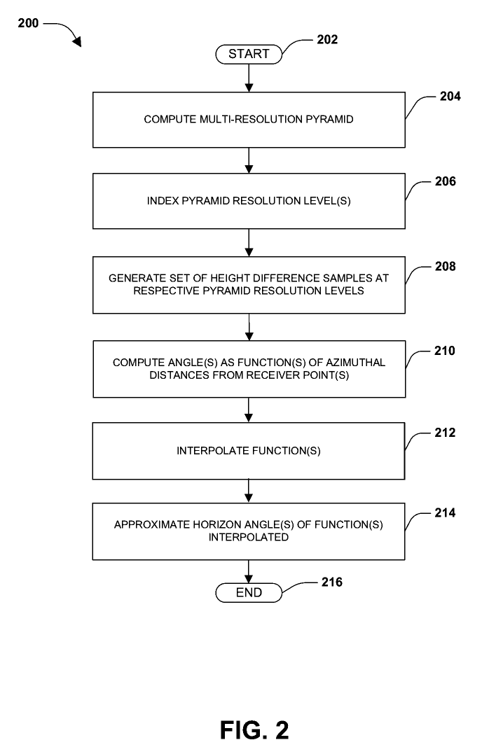

Referring now to FIG. 2, a method 200 is illustrated of extracting a horizon map for rendering soft shadows onto objects from a light environment in a computer simulation environment (e.g., a map of the surface is reproduced of the height fields and of the blocking angles from multiple points at varying distances). This will later be used for representing the soft shadows graphically as a spherical harmonic representation in a digital image, or a terrain in a flight simulator, for example, as one embodiment. After initializing at 202, a multiple resolution pyramid is applied over a height field at 204. The height field is defined as a height for points on a given plane.

In one embodiment, fewer samples of the height difference between a given receiver point and many shadow castor points are taken as distance away from a receiver point increases, wherein a receiver point is a point on which a shadow is being cast and a shadow castor point is a point blocking light. This can be done by filtering geometry of a given object using the multiple resolution pyramid (e.g., taking fewer samples as the distance increases away from the receiver point). The result is a smoother and a more filtered version of the geometry as the distance away from the receiver point increases. In other words, the multiple resolution pyramid allows an approximation of the geometry and therein provides an increasingly smoother version of the geometry as the distance away from it increases. For example, twice as many samples may be taken at a first distance from a receiver point than at a second point twice as far away resulting in a more realistic shadow. In another example, samples are taken at one resolution level such as 512×512 pixel resolution, and then at another resolution level. The sampling rate becomes less and is logarithmic as distance increases from the receiver point. Other rates can also be envisioned.

To approximate and evaluate the blocking angles of the sample, a multiple resolution pyramid is used. Respective pyramid levels (or scales) are denoted ƒₜ(x,y), t ∈ (0,1, . . . , N−1), with corresponding sample spacing Δₜ=b^{-t} where b=2 [symbol] controls the sampling step between levels. This sample spacing assumes the entire extent to the height field is normalized to unit length at each pyramid level. The level step is denoted as k. So, k=1 is a standard power-of-2 pyramid; larger k yield a finer transition between levels; i.e. xtra levels for each power of 2 reduction in sample spacing. The pyramid is constructed on the original tabulated height field data by repeated decimation using a b-spline resampling, such as a bicubic bspline reconstruction, for example, which is an interpolation technique. N is the total number of pyramid levels. A multiple resolution pyramid is one way for expressing approximate computations to scale-space representation.

A resolution pyramid may comprise a lowpass pyramid and/or a bandpass pyramid. A resolution pyramid may be generated by first smoothing the image with an appropriate smoothing filter and then subsampling the smoothed image, usually by a factor of two or power of two along each coordinate direction. As this process proceeds, the result will be a set of gradually more smoothed images, where in addition the spatial sampling density (e.g., the number of samples of a shadow image) decreases level by level. If illustrated graphically, this multi-scale representation will look like a pyramid, from which the name has been obtained. For example, an image may begin with a 512×512 resolution and next a 256×256 resolution height field may be viewed. The height field may then go to a 128×128 resolution and so on, getting smaller and to the top resulting in an average value of the height field or image for that single sample. Alternatively, a resolution pyramid may be obtained by forming the difference between adjacent levels in a pyramid, where in addition some kind of interpolation is performed between representations at adjacent levels of resolution, to enable the computation of pixelwise differences, as with a bandpass pyramid.

The method 200 continues at 206 by indexing pyramid resolution levels that may be courser as the distance from a castor point to a receiver point increases. In one embodiment, the multiple resolution pyramid is not limited to the standard power of 2 pyramid in dealing with multi-resolution image processing. For example, finer steps between levels can be used for typical height fields, such as having four different resolution levels between the resolution level 512×512 and the resolution level 256×256, for example, in addition to other resolution levels. The disclosure herein is not limited to any particular number of levels between standard resolution levels differing by a factor of two. The method 200 comprises the multiple resolution pyramid comprising pyramid resolution levels differing by a power of two from one another and comprising pyramid resolution levels between the pyramid resolution levels differing by a power of two with smaller differences. In addition, the pyramid resolution levels can differ by a factor of 2^{1/k}, where k is any number from a set of numbers comprising non-integers and integers. For example, the resolution levels 310×310 and 256×256 comprise differences that are not of a factor of two or a power of two, however the disclosure is not limited to any particular level of resolution.

To compute shadows on the height field in a given azimuthal direction according to one aspect of the present disclosure, a desired blocking or horizon angle in that direction is approximated. The method 200, using the multiple resolution pyramid computed at 204 and the indexed pyramid resolution levels 206, generates a set of height difference samples at respective pyramid resolution levels 208. This can be done by sampling the height difference between a given receiver point on the height field (i.e., point to be shaded, requiring a calculation of how much it is shadowed) and many shadow caster points on the height field at different distances away from the receiver point in a given azimuthal direction. In other words, the set of height difference samples are generated at respective pyramid resolution levels by sampling heights at a receiver point and at azimuthal distances in an azimuthal direction, and then subtracting the heights to get height difference samples. The resultant calculation is a sampling of a set of height differences in order to compute many different horizon angles for various azimuthal directions at points on the height field which is discussed at 210.

At 210 an angle as a function of distance is generated. The distance is fixed relative to sample spacing at each pyramid level; e.g. I=1. Height differences are sampled between a receiver point and neighboring caster points at the same pyramid level, using the concept of a multi-scale directional derivative. This approximates the arc tangent of the blocking angle as a function of distance from the receiver using a 2D bspline reconstruction, for example, or an interpolation technique. Alternatively, a bilinear interpolation can be used. To sample these height differences at distances far from the receiver point, a coarse pyramid level can be used to prefilter the height variations. Closer to the receiver point, finer pyramid levels can be used, giving a more exact approximation of the height difference that is sampled more densely. The multi-resolution pyramid can determine a sampling density which increases only logarithmically with increasing distance (i.e., linearly with increasing distance scale) to the receiver, and applies proper prefiltering to height variations at large distances, for example.

Shadowing in a given azimuthal direction can be computed by a multi-scale directional derivative (in terms of scale i, direction φ, distance dᵢ) according to the following equation:

$$D ( {f}_{t} , x , ϕ , {d}_{t} ) = \frac{{f}_{t} ( x + {d}_{t} cos ϕ , y + {d}_{t} sin ϕ ) - {f}_{t} ( x , y )}{{d}_{t}} \qquad ( 1 )$$

where dₜ=l Δₜ. A The directional derivative can be computed by subtracting two nearby evaluations of the function ƒₜ(x,y) and multiplying by the constant 1/dₜ (the reciprocal can be precomputed once, saving the cost of a divide). This is a local computation well suited for pipelined architectures (SSE) and SIMD GPUs. On CPUs, the interpolation can be accelerated by exploiting evaluation order at successive x, since these successive evaluations can easily be arranged to happen at the same y value.

The directional derivative determines the arc tangent of angle(s) as functions(s) of azimuthal distances from receiver point(s) (at scale i, in direction Φ, at distance of | relative to the sample spacing Δᵢ) for light arriving from the given azimuthal direction, as one example of calculating the angle as a function of azimuthal distances form a given receiver point. This blocking angle at scale i is given by the following equation:

ωᵢ(x,φ,dᵢ)=tan⁻¹(D(ƒᵢ,x,φ,dᵢ)). (2)

In computing the above derivative, smooth reconstruction or an interpolation is used at 212 when evaluating the first term since it does not in general lie exactly on a sample point. In one example, bicubic bspline interpolation is used for reconstructing a continuous function ηᵢ(x,y), such as a 2D or two dimensional interpolation. However, a bilinear reconstruction may be used, for example, in a CPU implementation.

According to one aspect at 212 a horizon map is extracted for a set of azimuthal directions by approximating a horizon angle of the interpolated angles as a function of azimuthal distance. Another interpolation is performed to convert the angles as a function of azimuthal distances at each pyramid level to a continuous function.

In one embodiment, an interpolation, such as a smooth interpolation, is used to convert a sequence of angles as a function of azimuthal distance at each pyramid resolution level of a multiple resolution pyramid to a substantially continuous function. This interpolating is done for each pyramid resolution level of the multiple resolution pyramid, for each azimuthal direction, and each receiver point sampled. A 1D bspline interpolation is another example of the smooth interpolation used in accord with the embodiment by the following equation:

ω(τ,x,φ)=bspline(τ,{ωₙ(x,φ, dₙ),ω₁(x,φ,d₁), . . . ,ω_{N-1}(x,φ,d_{N-1})}); (3)

The parameter x represents negative log distance away from the receiver point. B-spline interpolation takes each sequence of consecutive values and an interpolant representing blending distance between the values at log distances sampled. Alternatively the sample could be from a linear distance.

Another embodiment is to provide control over the multi-resolution approximation, by specifying a level offset, o, which offsets each level evaluated in equation 3. The level offset biases each pyramid resolution level by adding ko, i.e., by evaluating f_{|i+ko|} instead of fᵢ, for example. The pyramid resolution level accessed is biased and the distance dᵢ in the multi-scale directional derivative is preserved. Increasing the level offset in another embodiment can result in sharper shadows at the cost of increased sampling requirements. Sampling can eventually result from the original, unfiltered height field with large offsets.

Finally, the approximate of the interpolated function at 214 is taken over the parameter τ, or the log distance away from the receiver. This approximation yields a horizon angle for the continuous smooth curve. The horizon angle is an approximated maximum blocking angle of the curve in an embodiment according to the following equation:

ω(x,φ) [symbol] ω(t,x,φ) (4)

A maximum blocking angle, for example, is constrained to be non-negative by taking a final max with equation 4 with zero. This ensures that none of the hemisphere below the height field contains directions where the sky is visible.

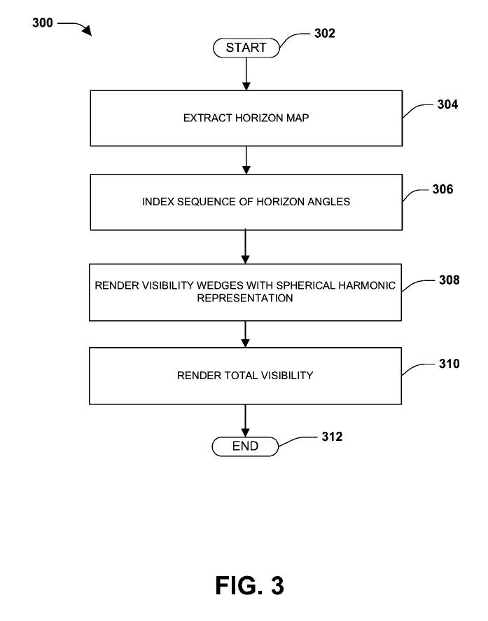

Referring now to FIG. 3, a method 300 for how to efficiently generate soft shadows given a horizon map according to one aspect is illustrated. After initializing at 302, the method 300 proceeds to extracting a horizon map 304 of a given height field for a terrain by any suitable means, such as discussed above. In one embodiment a respective consecutive or sequential pair of horizon angles is converted to a visibility wedge represented using order-4 spherical harmonics (SH), and a total visibility vector accumulated over the wedges indexed. When the lighting is azimuthally directional, the method may also be implemented to restrict the visibility computations to a partial swath for obtaining sharper shadows.

At 306 sequential pairs of horizon angles that are approximately maximum horizon angles are indexed in memory. Self-visibility or self-shadowing on a continuous height field can be represented by the maximum elevation angle it attains as a function of the shadow's location and azimuthal direction (e.g., the angle that the horizon make at each spot as one gradually turns around). The horizon map extracted at 304 applies this observation over a discretized set of directions. The method 300 approximates maximum elevation angles as a function of location and azimuthal direction on-the-fly and uses them to render soft shadows, both in real-time, as well as locally on the chip.

At 308 soft shadowing or self-visibility is rendered with a spherical harmonic representation according to another aspect. A respective consecutive sequence or sequential pair of horizon angles is converted to a visibility wedge represented using order-4 spherical harmonics (SH), and a total visibility vector accumulated over the wedges indexed. When the lighting is azimuthally directional, the method may also be implemented to restrict the visibility computations to a partial swath for obtaining sharper shadows.

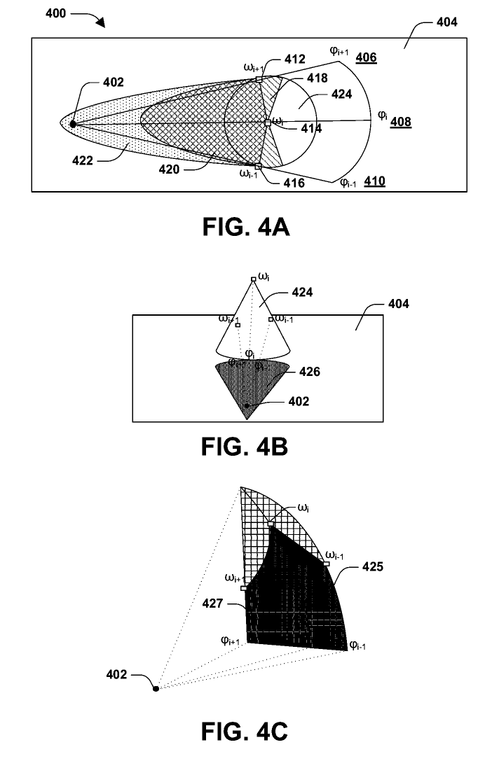

The method at 308 is illustrated further by FIGS. 4A, 4B, and 4C which illustrate visibility wedges 400 on a height field 404 plane from receiver point 402 in azimuthal direction samples 406, 408, and 410, for example. FIG. 4C illustrates a visibility function interpolated using linear interpolation between the discrete samples at 408 and projected in the sphere directions to define two visibility wedges 425, and 427. A cone 424 is casting a shadow upon a point 402. Shadows 418, 420, and 422 are crudely etched to illustrate a continuing difference in hard and soft shadowing generated by a light source (not shown). The transitions between shadowing, for example, from hard to soft shadows are continuous in appearance, as for example a shadow 426 in FIG. 4b. The shadow 426 however is not able to perfectly depict the transitions from hardness to softness as distance increases due to rudimentary drawing restrictions.

The space of directions emanating from receiver point 402 are represented via unit vectors (s) (not shown) parameterized by the azimuthal direction samples 406, 408, 410, φ ∈ [0,2π] and elevation angle θ ∈[−π/2, +π/2]:

s(φ,θ)=(cos φ cos θ, sin φ cos θ, sin θ). (5)

The elevation angle is zero if the corresponding direction skirts the height field plane, and π/2 if it points straight up, out of this plane.

At a given receiver point 402, a sequence of blocking angles ω(x,φₜ) is obtained over the azimuthal direction samples 406, 408, and 410, for example. Each consecutive pair or sequence of azimuthal directions (φ₁, φᵢ₊₁) determines a continuous blocking wedge or visibility wedge as seen from the receiver point 402 with corresponding horizon blocker angles (ω₁, φᵢ₊₁). To reconstruct a continuous visibility function, ω(φ), we simply assume that the blocking angle varies linearly from ωᵢ to ωᵢ₊₁ as a function of φ between φᵢ and φᵢ₊₁ yielding the following:

$$ω ( ϕ ) = {ω}_{t} + \frac{ϕ - {ϕ}_{t + 2}}{{Δ}_{ϕ}} ( {ω}_{t + 1} - {ω}_{t} ) , \qquad ( 6 )$$

where the angular distance between azimuthal direction samples 406, 408, 410 is denoted Δ_{φ}=φᵢ₊₁−φᵢ.

The visibility function is given by

$$τ ( ϕ , θ ; {ϕ}_{t} , {ϕ}_{t + 1} , {ω}_{t} , {ω}_{t + 1} ) = \{ \begin{matrix}0 , & ϕ ⋐ [ {ϕ}_{t} , {ϕ}_{t + 1} ] and θ \leq ω ( ϕ ) \\ 1 , & otherwise .\end{matrix} \qquad ( 7 )$$

where φ is an azimuthal component and θ is an elevation component of each direction s=(φ,θ). So v indicates whether a ray emanating from the receiver point in the direction misses the height field 404 or not, and so is able to “see the sky” in that direction.

By canonically repositioning each blocking wedge so that φ₁=θ, and assuming a fixed Δ_{φ}, a low-order spherical harmonic (SH) projection of the blocking wedge function is precomputed in terms of the two blocking angles (ω₁, ωᵢ₊₁). This can be stored as a 2D table which produces the SH visibility vector. This table may, for example, be denoted as ν(ωₐ,ω_{b}) and its corresponding continuous function as ν(s; ωₐ,ω_{b}). An order-4 SH is used in one embodiment, for example, which produces 16D visibility vectors. The visibility wedge table θ(ωₐ,ω_{b}) is computed using numerical integration over the sphere for each pair of elevation angles.

At 310 of method 300 a total visibility is rendered providing soft shadows with hard shadows. The SH visibility vectors are summed over all the blocking wedges for each consecutive pair of azimuthal direction samples. This gives the total SH visibility vector in the azimuthal swath. A total shade is then given by a vector dot product.

For small azimuthal swaths, this method actually obtains much sharper shadows than can ordinarily be realized with low order SH. This is because our visibility basis functions are restricted (and precomputed) for these small blocking wedges. As the azimuthal swath approaches the complete swath, the shadow sharpness decreases until it is ultimately limited by the SH order used. For example, shadows from a cone 424 are much sharper than can be realized with a complete swath visibility at SH order 4. For example, when the wedge or azimuthal swath spanned is approximately 200.

The method 200 and/or 300 may be implemented on a graphics processor GPU or a central processor CPU, for example on DirectX10 for a GPU. The height pyramid can be build on-the-fly on the GPU given the highest resolution height field fN−1. Successive bilinear decimations are applied fine-to-coarse to pre-filter the data, followed by bicubic b-spline interpolation back up to the original resolution. The computation thus takes 2*N shader passes, for example. This creates an “image array” representing the multiple resolution pyramid for the height field which is subsequently accessed using bilinear interpolation to evaluate the multi-scale directional derivative in equation 2, discussed supra. Reconstructing the smoothed result once in a preliminary pass avoids doing it for every azimuthal direction. Multiple image arrays may also be used to avoid resampling coarse pyramid levels all the way back to the original resolution.

In another example two different types of light sources may be used to shade the height field. Environmental light comes from all around the height field and uses a complete azimuthal swath to provide a very soft shadow. Secondly, key light represents a smaller, more directional source and uses a partial azimuthal swath to provide sharper shadows. Both are represented as 16D SH vectors and are derived from HDR light probes or analytic circular sources. When sampling visibility, n_{φ}=16 azimuthal directions for environmental lights may be taken and many fewer (e.g. 3) for key lights.

In another embodiment, a separate shading pass can be computed for each type of light. Multiple key lights are computed in separate passes unless they share an identical azimuthal swath. Because of the smoothness of shadows from environmental lighting, another embodiment is to avoid b-spline interpolation entirely and instead compute the max only over pyramid levels. Avoiding interpolation also lets us compute inverse tangent just once after taking the maximum instead of a number times at each pyramid level. The more expensive visibility computation in equations 4 and 5 is still performed for key lights.

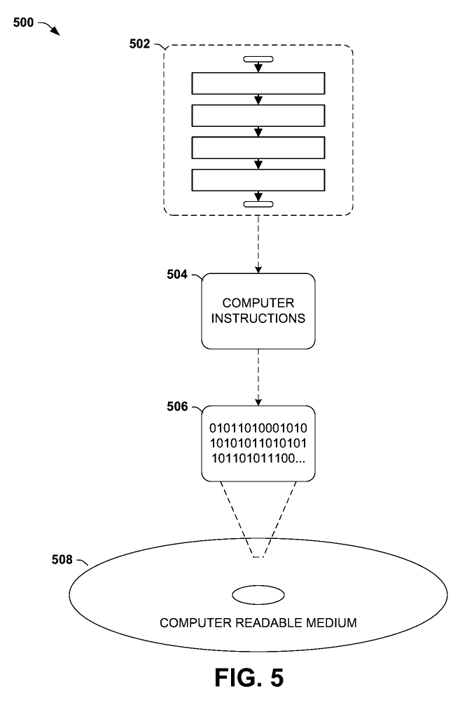

Still another embodiment involves a computer-readable medium comprising processor-executable instructions configured to implement one or more of the techniques presented herein. An exemplary computer-readable medium that may be devised in these ways is illustrated in FIG. 5, wherein the implementation 502 comprises a computer-readable medium 508 (e.g., a CD-R, DVD-R, or a platter of a hard disk drive), on which is encoded computer-readable data 504. This computer-readable data 504 in turn comprises a set of computer instructions 506 configured to operate according to one or more of the principles set forth herein. In one such embodiment 502, the processor-executable instructions 506 may be configured to perform a method, such as the exemplary method 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

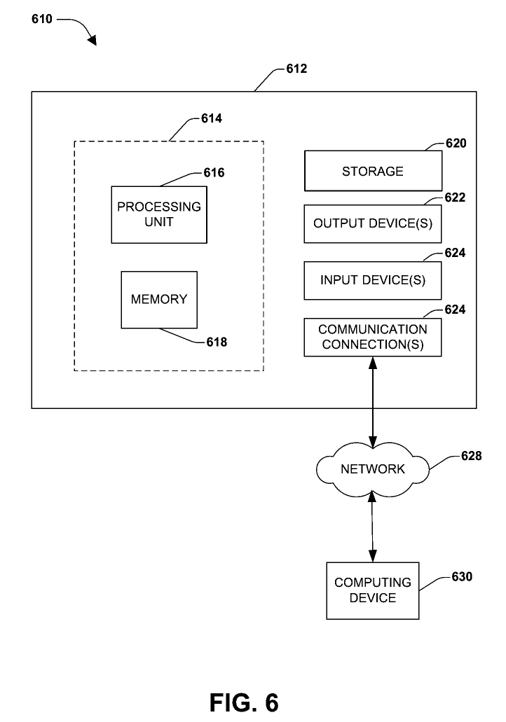

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 610 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of computing a horizon map from a multiple resolution pyramid, comprising:
computing a multiple resolution pyramid comprising pyramid resolution levels differing by a factor of 2^{1/k}, where k is any number from a set of numbers comprising non-integers and integers;
indexing pyramid resolution levels increasing in resolution coarseness corresponding respectively to an increase in a distance from a shadow castor point to a receiver point;
generating a set of height difference samples at respective pyramid resolution levels by sampling heights at a receiver point and at azimuthal distances in an azimuthal direction, and subtracting the heights to get height difference samples;
computing angles as a function of azimuthal distances from the receiver point;
approximating a horizon angle of the angles as a function of azimuthal distances.

2. The method of claim 1, using a multi-scale derivative to compute the angles as a function of azimuthal distances.

3. The method of claim 1, generating the set of height difference samples comprising:
computing a height difference between the receiver point and shadow castor points for respective distances at a corresponding pyramid resolution level for the azimuthal direction.

4. The method of claim 2, the multi-scale derivative approximating the function comprising a tangent of the angles as a function of azimuthal distances from the receiver point.

5. The method of claim 1, approximating the horizon angle comprising approximating a maximum horizon angle of the function generated by interpolating the function using an interpolation.

6. The method of claim 5, the interpolation comprising a 1D bspline interpolation or a bilinear interpolation.

7. The method of claim 1, where height differences are determined using a 2D bspline interpolation with the multiple resolution pyramid.

8. The method of claim 1, where the angles are computed with an arc tangent of the multi-scale derivative

9. The method of claim 1, the multiple resolution pyramid comprising coarser pyramid levels for pre-filtering height variations as distances increase from the receiver point to the shadow castor point, and finer pyramid levels for pre-filtering height variations as distances decrease.

10. The method of claim 1, the multiple resolution pyramid determining a sampling density that increases logarithmically with increasing distance towards the receiver point, and applying increased pre-filtering to height variations as distances increase from the receiver point.

11. A method for rendering soft shadowing onto a horizon map comprising:
extracting a horizon map from a set of sample points indexing a sequence of horizon angles;
rendering visibility wedges from the sequence of horizon angles by using an area-supported basis for a visibility hemisphere; and
rendering a total visibility at the set of sample points from visibility wedges represented by the area-supported basis for the visibility hemisphere.

12. The method of claim 11, comprising:
generating an environmental visibility sample at sample points on the horizon map, parameterized by a complete swath (cos φ, sin φ), φ ∈ [0, 2π]; and
generating a key lighting sample from sample points on the horizon map, parameterized by a partial azimuthal swath.

13. The method of claim 11, comprising computing visibility wedges in a partial azimuthal swath, and extracting the horizon map using a multiple resolution pyramid comprising levels of resolution differing by a factor of 2^{1/k}, where k is any number from a set of numbers comprising non-integers and integers, and applying an interpolation to angles therein.

14. The method of claim 13, the interpolation comprising a smooth interpolation converting angle samples at respective pyramid resolution levels of a multiple resolution pyramid to a substantially smooth function that is continuous according to a first equation as follows:
ω(τ,x,φ)=bspline(τ,{ωₙ(x,φ,dₙ),ω₁(x,φ,d₁), . . . ,ω_{N-1}(x,φ,d_{N-1})});
ωᵢ denoting a angle sample at respective pyramid resolution levels i;
x denoting a receiver point, φ denoting an azimuthal direction, and dᵢ denoting distance; and τ defining a space parameter of negative log distance away from the receiver point; and
computing a horizon angle from the substantially smooth function according a second equation as follows:
ω(x,φ) [symbol] ω(τ,x,φ)

15. The method of claim 14, the horizon angle from the substantially smooth function according to the second equation is an approximately maximum horizon angle.

16. The method of claim 11, the area-supported basis for the visibility hemisphere is a spherical harmonic representation.

17. The method of claim 12, comprising generating approximately sixteen environmental lighting samples for rendering an environmental light, and approximately three key lighting samples for rendering a key light.

18. A method of extracting a horizon map and rendering soft shadows thereon from a light environment comprising:
computing a multiple resolution pyramid on a height field, the multiple resolution pyramid comprising pyramid resolution levels differing by a factor of 2^{1/k}, where k is any number from a set of numbers comprising non-integers and integers;
indexing the pyramid resolution levels increasing in resolution coarseness corresponding respectively to an increase in distance from a shadow castor point to a receiver point;
generating a set of height difference samples at respective pyramid resolution levels by sampling heights at a receiver point and at azimuthal distances in an azimuthal direction, and subtracting the heights to get height difference samples;
computing angles as a function of azimuthal distances from the receiver point using a multi-scale derivative approximating the function comprising an arc tangent of a horizon angle as a function of a distance from the receiver point;
interpolating the function;
approximating the horizon angle that is an approximately maximum horizon angle of the function interpolated by interpolating again;
indexing sequential pairs of horizon angles and converting the sequential pairs into visibility wedges represented using a spherical harmonic basis of fourth order, the visibility wedges restricted to a partial azimuthal swath less than 2π;
rendering a total visibility at the set of height difference samples from the visibility wedges represented by a spherical harmonic representation.
the light environment comprising a key light and/or environmental light,
the multiple resolution pyramid determining a sampling density that increases logarithmically with increasing distance towards the receiver point, and applying increased pre-filtering to height variations as distances increase from the receiver point.

19. The method of claim 18, where the environmental light is a broader light than the key light.

20. The method of claim 18, where interpolating comprises a 1 dimensional bspline interpolation, a bilinear interpolation, or a 2 dimensional bspline interpolation.
